(19) United States
(12) Patent Application Publication
(10) Pub. No.: US 2006/0085989 A1
(43) Pub. Date: Apr. 27, 2006

(54) Foldable cutting board

(76) Inventor: Feng-Hsia Kuan Huo, Chung Ho City (TW)

Correspondence Address: LEONG C LEI, PMB # 1008, 1867 YGNACIO VALLEY ROAD, WALNUT CREEK, CA, 94598, US

(21) Appl. No.: 10/970,392

(22) Filed: Oct. 22, 2004

(51) Int. Cl. B26B 3/06

(52) U.S. Cl. 30/151; 30/298.4

(57) ABSTRACT

A foldable cutting board supplemented with a cutting knife is disclosed. The cutting board comprises a board body and a knife shield, characterized in that one lateral edge of the board body is mounted with the knife shield inserting the cutting knife, and on the surface and along all the edges of the board body, liquid collecting slots are provided, and one or more cutting slots are positioned on the board body which is substantially parallel to the lateral edge of the board body, wherein the cutting slots are connected with thin film, and the cutting slots cause the cutting board to be folded to form a plurality of stackable cutting boards.

### BACKGROUND OF THE INVENTION

(a) Technical Field of the Invention

The present invention relates to a cutting board, and in particular, to a foldable cutting board supplemented with a cutting knife.

(b) Description of the Prior Art

Cutting boards are either made from wood or plastic material. In order to save space and facilitate storage, cutting boards tend to be made small. However, smaller cutting boards are not welcome as they are not useful when large size things needs to be cut. In view of the above, it is an object of the present invention to provide a foldable cutting board, which facilitates application and storage as the cutting board can be folded. Further, a knife is provided on the cutting board.

### SUMMARY OF THE INVENTION

Accordingly, it is an object of the present invention to provide a foldable cutting board supplemented with a cutting knife comprising a board body and a knife shield, characterized in that one lateral edge of the board body is mounted with the knife shield inserting the cutting knife, and on the surface and along all the edges of the board body, liquid collecting slots are provided, and one or more cutting slots are positioned on the board body which is substantially parallel to the lateral edge of the board body, wherein the cutting slots are connected with thin film, and the cutting slots cause the cutting board to be folded to form a plurality of stackable cutting boards.

Yet another object of the present invention is to provide a foldable cutting board, wherein the rear side of the cutting board is provided with three cutting slots, and the two cutting slots proximity to the knife shield a thick folding wall having a substantial width and thickness, such that when folding the thick folding wall, the cutting board can be folded into three layers.

Still another object of the present invention is to provide a foldable cutting board, wherein the surface of the knife shield facing a desk, corresponding to the deepest position of the cutting knife a gripping recess is formed.

A further object of the present invention is to provide a foldable cutting board supplemented with a cutting knife, wherein the knife is conveniently withdrawn from the knife shield without looking for another knife for cutting food stuff.

Other objects and advantages of the present invention can be more fully understood by reading the following detailed description of the preferred embodiments, with reference to the accompanying drawings.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of the extended foldable cutting board supplemented with a cutting knife of the present invention.

FIG. 2 is a perspective view of the folded cutting board of the present invention.

FIG. 3 is a bottom view of the folded board of FIG. 1 of the present invention.

FIG. 4 is a perspective view of another preferred embodiment of a foldable cutting board of the present invention.

FIG. 5 is a perspective view of a folded cutting board in accordance with another preferred embodiment of the present invention.

FIG. 6 is a perspective view of an extended cutting board of another preferred embodiment of the present invention.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

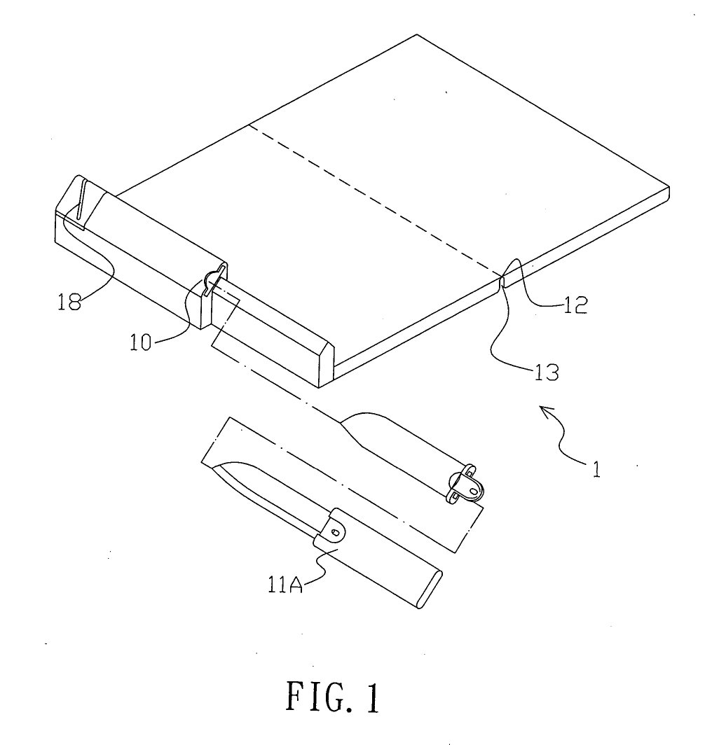

FIG. 1 is a perspective view of a foldable cutting board 1 supplemented with a cutting knife 11 having a board body which is resistant to cutting. One edge of the board body is mounted with a knife shield 10. The knife shield 10 has a sloping top surface and the cutting knife 11 is inserted into the knife slot 11C. A knife-releasing button 11D and a knife button 11E are mounted between the knife 11A and the knife slot 11C. The tightness of the knife 11A and the knife slot 11C is greater than the knife shield 10 and the knife slot 11C. The knife 11A is released from the knife slot 11C for cutting food stuff, such as meat or vegetable on the cutting board 1. This saves time in looking for a knife for cutting food stuff. At an appropriate interval from the edge of the cutting board 1, at least a cutting slots 13 are provided and a thin film 12 is connecting the cutting slots 13.

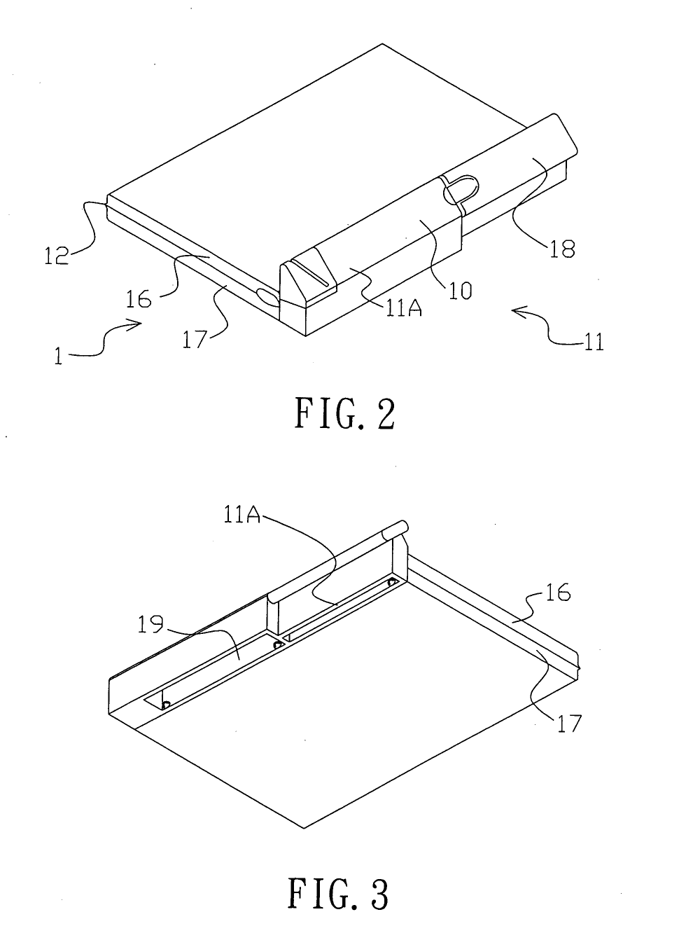

As shown in FIG. 2, the board body can be folded along the cutting slots 13 to form into two layers cutting boards 16, 17. The external end face of the knife shield 10, at an appropriate position which is the furthest position of the insertion of the cutting knife, a knife piling slot 18 is provided.

Referring to FIG. 3, there is shown the bottom view of a folded cutting board of the present invention. The knife shield 10 is provided with a gripping slot 19 so that the fingers of the user can hold the cutting board at the gripping slot 19.

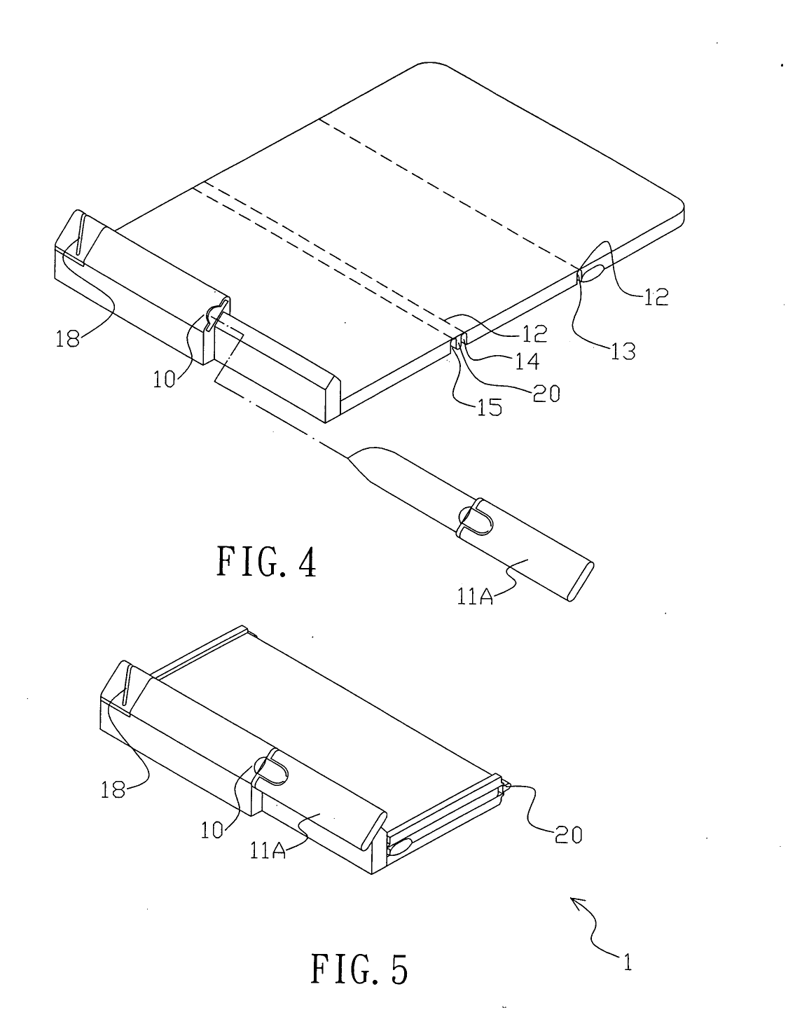

In another preferred embodiment, the cutting board 1 can be folded into three pieces, which is shown in FIG. 4. The surface of the cutting board is a thin film 12 and the back of the cutting board is provided with three cutting slots 13, 14, 15 and a thick wall 20 is formed between two cutting slots 14, 15. When the cutting board is folded, the cutting board is shown in FIG. 5. The thick wall 20 allows the innermost board to be folded into three layers and to be enclosed into the innermost layer of the block body 17. The furthest side of the cutting board, when it is extended, a block 22 is provided. The rear side of each of the blocks 16, 17 are recessed so that the rear edges of the block bodies 16, 17 are formed into supporting ribs.

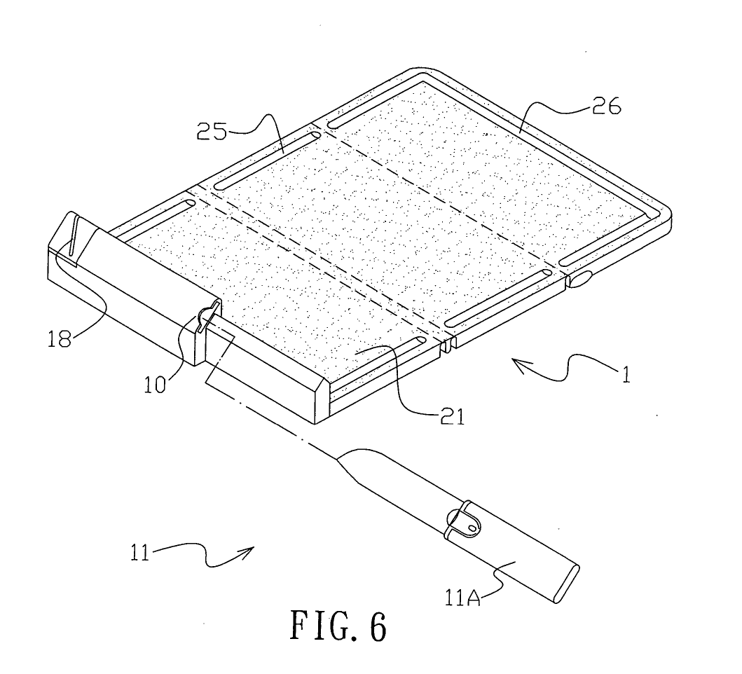

As shown in FIG. 6, the surface of the cutting board is a matt surface 21 which is resistant to cutting and does not leave cutting marks on the cutting board. Further, the cutting board is not slippery so as to pick up food stuff on the cutting board. Water collection slots 25, 26 are provided along the edges of the cutting board. The slots 25, 26 collect water or liquid coming out from food stuff.

While the invention has been described with respect to preferred embodiments, it will be clear to those skilled in the art that modifications and improvements may be made to the invention without departing from the spirit and scope of the invention. Therefore, the invention is not to be limited by the specific illustrative embodiment, but only by the scope of the appended claims.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A foldable cutting board supplemented with a cutting knife comprising a board body and a knife shield, characterized in that one lateral edge of the board body is mounted with the knife shield inserting the cutting knife, and on the surface and along all the edges of the board body, liquid collecting slots are provided, and one or more cutting slots are positioned on the board body which is substantially parallel to the lateral edge of the board body, wherein the cutting slots are connected with thin film, and the cutting slots cause the cutting board to be folded to form a plurality of stackable cutting boards.

2. The foldable cutting board of claim 1, wherein the rear side of the cutting board is provided with three cutting slots, and the two cutting slots proximity to the knife shield a thick folding wall having a substantial width and thickness, such that when folding the thick folding wall, the cutting board can be folded into three layers.

3. The foldable cutting board of claim 1, wherein the surface of the knife shield facing a desk, corresponding to the deepest position of the cutting knife a gripping recess is formed.

4. The foldable cutting board of claim 1, wherein the external end face of the knife shield, distant away from the farthest position of the insertion of the cutting knife, a knife-piling slot is provided.

5. The foldable cutting board of claim 1, wherein the board surface of the cutting board, a hand matt surface is made.

6. The foldable cutting board of claim 1, wherein the surface of the cutting board, a distance away from the edge of the cutting board, liquid collection slot is provided.

7. The foldable cutting board of claim 1, wherein the innermost layer of the cutting bodies, at the furthest edge of the pivoting position of the cutting bodies, a block is provided facilitating opening of the cutting bodies.

8. The foldable cutting board of claim 1, wherein the rear side of each of the cutting bodies is provided with support ribs.
